(19) United States
(12) Patent Application Publication
(10) Pub. No.: US 2007/0073436 A1
(43) Pub. Date: Mar. 29, 2007

(54) Robot with audio and video capabilities for displaying advertisements

(76) Inventor: John C.K. Sham, Hong Kong (HK)

Correspondence Address: Peter S. Canelias;Law Offices of Peter S. Canelias, Suite 2148, 420 Lexington Avenue, New York, NY, 10170, US

(21) Appl. No.: 11/526,456

(22) Filed: Sep. 25, 2006

Related U.S. Application Data
(60) Provisional application No. 60/720,548, filed on Sep. 26, 2005.

(51) Int. Cl. G06F 19/00

(52) U.S. Cl. 700/164

(57) ABSTRACT

The invention is an autonomous robot configured with audio and video display mechanisms for displaying advertisements to an audience. The advertisement data may be stored locally within the robot, transmitted through a wired docking/recharging station or provided via the Internet, through a wired or wireless connection. The robot can receive different forms of digital signals and information such as digital photos or video and output to the display, and it can receive control commands and messages from the server and/or another robot. The server can be located on site or control the robot through Internet. The robot is able to distinguish the target individuals or groups as adults, children, or physical objects, and will provide different actions such as singing songs, dancing, playing music or the like to attract the attention of the target audience for the purpose of displaying adverting material.

### CROSS REFERENCE TO RELATED APPLICATION

This application claims priority to provisional application for patent Ser. No. 60/720,548, filed Sep. 26, 2005, which is incorporated herein by reference in its entirety and for all purposes.

### BACKGROUND OF INVENTION

The invention relates to robots, and particularly mobile robots for use in drawing (attracting) and entertaining an audience in a public space with the capability of displaying advertisements both visual and audible, to the audience. The base robot design is known to persons of skill in the art and may be formed with a variety of features. Some of these robot embodiments are disclosed in U.S. Pat. No. 6,038,493 to Tow for an invention titled “Affect-Based Robot Communication Methods and Systems”, which is incorporated herein by reference in its entirety and for all purposes, but particularly for purposes of 35 U.S.C. 112. However, none of the prior art robot devices are configured to attract an audience and then display advertising material to that audience, from different data sources such as a local data storage device, an onsite data system, or a remote data system communicating through a global computer network such as the Internet.

### SUMMARY OF THE INVENTION

The invention is a robot for use in drawing and entertaining an audience in a public space with the capability of displaying advertisements both visual and audible, to that audience. To accomplish this, the robot is preferably equipped with a mobile base comprising wheels and is driven by a DC motor(s) with rechargeable batteries. The robot has at least one display, and may provide multiple displays of one or more types, such as a traditional cathode ray tube (CRT), a liquid crystal display (LCD), organic light emitting device or diode (OLED) or Plasma, to show different forms of information to the surrounding audience. The battery provides power to the robot electronics, the robot motor and to the display and speakers.

The robot may be equipped with an electronic processing unit to control the navigation, power management, communication, operation and information display. The robot uses autonomous navigation and localization equipment known in the art, and is preferably equipped with upper and lower sensors to detect objects or obstacles in all directions. This enables the robot to turn away from nearly all obstacles, except for members of a target audience. The robot may also be equipped with a known, prior art steps/stairs detection mechanism in order to prevent the robot unit from toppling when reaching steps or stairs. The robot is also preferably equipped with mechanical sensors such as bumper sensors as well as non-contact sensors such as infra-red, ultrasonic, laser-based sensing equipment and visual detection means such as cameras. For example, the robot unit can be equipped with a digital color stereo camera system for range (distance) finding and for three-dimensional (3-D) object detection.

The robot may be equipped with compass and tilt-position sensors for aiding in navigation and location detection. The robot can communicate with an operation server, or between robots, by wireless communication means such as WiFi, Bluetooth, etc. The robot unit may also be equipped with a positioning system to enable determination of its location when in an open area.

The robot can transmit different forms of analog and digital data signals and information such as digital photos for live capture from the built-in camera and/or video streaming from a built-in camera. In addition, control commands or messages to show the states of the robot to the server and/or the other robot are provided via wired or wireless means. The server can be located on-site or may control the robot through a communication network such as the Internet.

The robot may be able to distinguish the met target as an adult, child, or an object, and will provide different actions, such as singing, dancing, playing music or the like, depending on the reading of the target to attract the attention of the target for the purpose of displaying or playing advertisements on the spot.

The robot may be equipped with a docking system so that the robot unit will automatically go back to the charging base for battery charging when its battery is low. However, manual charging may also be provided to the unit.

Preferably, the robot should halt immediately when a potential risk is detected. The risks would include internal risk which is caused by the robot itself or any potential risk occurring outside which is detected by the sensors and analysis from the internal electronic processing unit. The robot may also be stopped by a control server where the commands are delivered through a wired or wireless connection, and may also include means to allow for a manual emergency stop and/or override.

### BRIEF DESCRIPTION OF THE DRAWINGS

The above-mentioned and other features and objects of this invention and the manner of obtaining them will become apparent and the invention itself will be best understood by reference to the following description of an embodiment of the invention taken in conjunction with the accompanying drawings, wherein:

FIG. 1 is a diagram showing a preferred embodiment of the invention and location of components;

FIG. 2 is a diagram showing a preferred embodiment of the invention and location of components with interaction of a wired link and docking station;

FIG. 3 is a diagram showing a preferred embodiment of the invention and location of components with interaction of a wireless link and on-site external advertisement data system;

FIG. 4 is a diagram showing a preferred embodiment of the invention and location of components with interaction through a wired or wireless link, a docking station, external advertisement data system and Internet access to an off-site advertisement data system;

FIG. 5 is an alternate embodiment of the robot body for use with the present invention.

### DETAILED DESCRIPTION

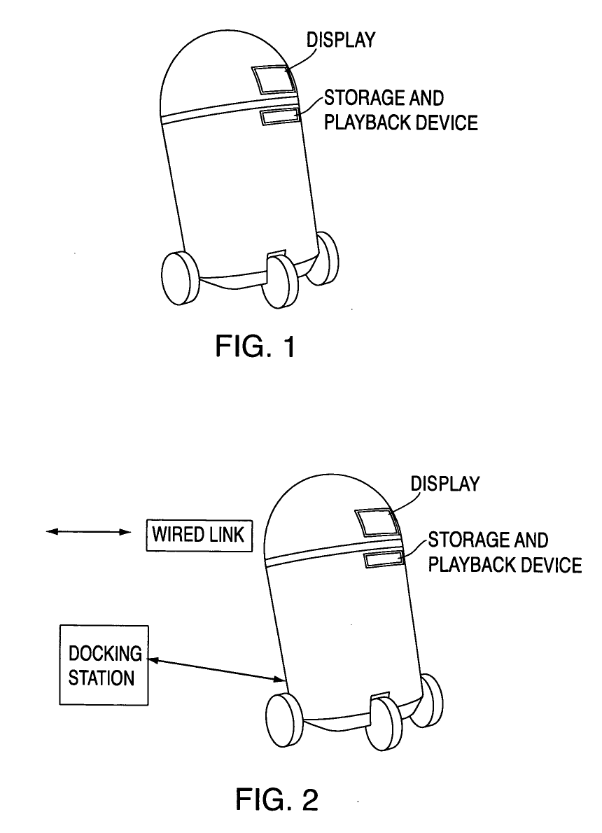

Reference is made to FIG. 1, showing a built-in advertisement data display (the display can be video, sound or data such as text). Also shown is a storage and playback device, where the playback device plays back pre-recorded video for advertisement purposes. The video playback device can be a video cassette recorder (VCR), solid state memory playback or DVD, VCD player. The latest technology such as Blue-ray playback machines also can be used in the invention. A computer with a media player installed, such as Windows Media Player, can also be considered a playback device. The storage portion of the storage and playback device may use computer memory or any other data storage medium. It can employ removable storage media such as videocassettes, video disks, memory cards, or other removable storage devices.

In FIG. 2, the advertisement data (can be video, sound or data) can also be updated when the robot is charging in the docking station. The advertising data is transmitted from the docking station through a preferably hardwire means and the format of the data can be an analog or digital format.

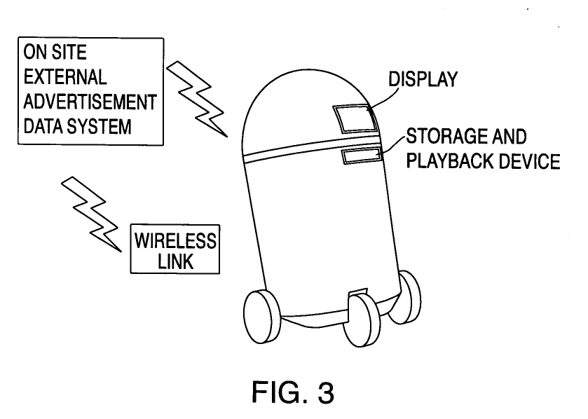

In FIG. 3, real time updating is also possible when the robot is traveling around the site by means of wireless communication such as WiFi, Bluetooth, or wireless analog data transmission. The data can also come from the other wireless device such as mobile phones or personal digital assistants (PDA) or combination-type devices.

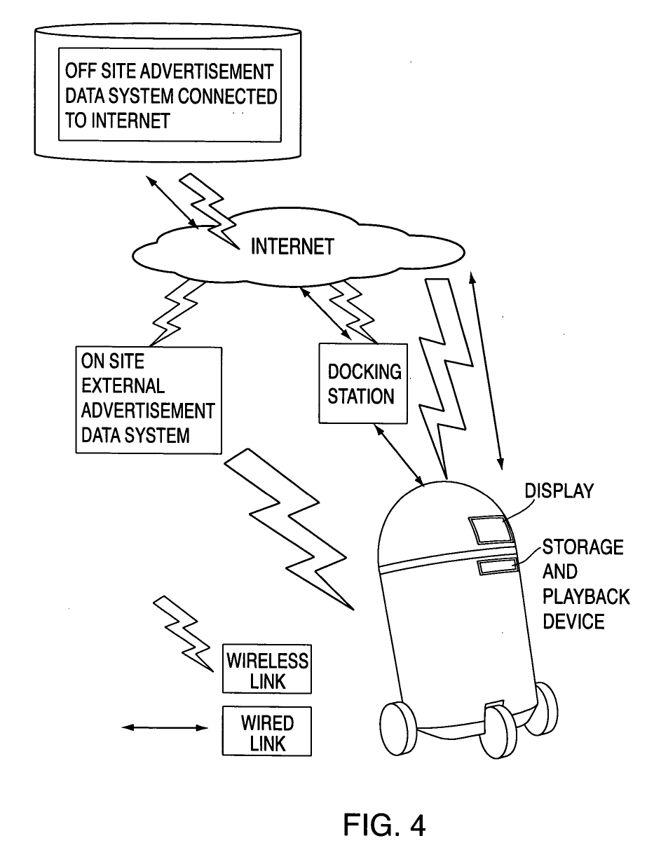

In FIG. 4, advertisement data can also transferred from anywhere through the Internet as the robot is connected to the Internet in this embodiment. The connection can be wired when it is operably engaged with the docking station, or wireless when the robot unit is in motion. When connected to the Internet, the data from the Internet can be stored in the external advertisement data system or docking station. The data signal may be transferred to the robot when is has engaged with the docking station or transferred from an on-site external advertisement data system through a wireless connection or link. The data signal can also be directly transferred to the robot from the off-site advertisement data when the robot is also connected to the Internet through a wireless or wired connection forming an operable data link. Off-site advertisement data can be in any form such as computer information, video information, voice information and will reside in any form of device or memory as it is connected to the Internet.

Real time data streaming is possible for this robot where the data can be transferred directly from an off-site advertisement data signal source connected to the Internet and where the robot is connected to the Internet, communicating through the docking station or data streaming through on-site external advertisement data storage. The difference is that real time data can be presented on the robot display (and to the robot itself).

All data transmission may be bi-directional. This means that the robot can acquire the data from external sources and in parallel with such acquisition will capture some data from its own recording devices. The captured data may be sent to the docking station and/or on-site or off-site advertisement data system. As previously stated in respect to FIG. 3, the external device to accept the data coming from the robot can be any form of computer, mobile phone or personal digital assistant (PDA) as long as the device can form the linkage, i.e., establish an operable data link, with the robot. The linkage can be wireless or wired.

The invention also contemplates a stored play list and schedule for the various media content. The play list and the schedule for the advertisement data can be also updated anytime by means of wireless or wired communication from an external controller. The external controller can be on site or anywhere connected to the Internet.

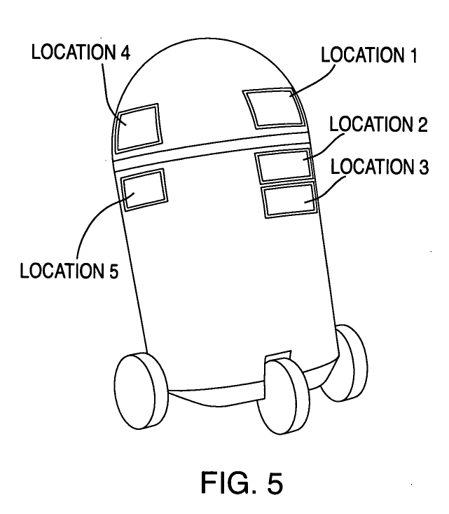

FIG. 5 shows an alternative body for the robot for use with the present invention. The body of the robot may be preferably shaped with a cylindrical body and a domed top portion. The display may be placed in the upper domed portion at about location 1, and/or in locations 2 and 3 in the cylindrical body portion, depending in part on the height or eye level of the anticipated audience, the angle of view, whether seated or standing, etc. The plurality of display devices that may be used with the present invention may be in an over-under configuration such as locations 1, 2 and 3 of FIG. 5, or may be laterally disposed about the circumference of the robot body as exemplified by locations 4 and 5 in FIG. 5, which is particularly suited for an audience formed in more or less a circle about the robot, or disposed about the circumference of the domed top portion. The advertisements displayed on any of the embodiments may be interspersed with entertainment such a songs, dialogue, video or other means of attracting and entertaining the audience.

Since other modifications or changes will be apparent to those skilled in the art, there have been described above the principles of this invention in connection with specific apparatus, it is to be clearly understood that this description is made only by way of example and not as a limitation to the scope of the invention. What is claimed is:

1. A display robot, comprising:
a robot body having a display for playing a data signal, the robot body carrying the display;
the robot body having a mobile base that allows the robot body to move along a surface;
the robot body having a power source for driving the robot body along the surface;
a storage device for storing the data signal in a medium, the storage device being in communication with a playback device;
the playback device being operably connected with the display, for playing back the stored data signal on the display.

2. The display robot of claim 1, wherein the display further comprises a speaker for playback of an audio data signal.

3. The display robot of claim 1, wherein the storage device further comprises a removable storage medium.

4. The display robot of claim 1, wherein the robot body further comprises a plurality of sensors to detect obstacles.

5. The display robot of claim 1, wherein the robot body has a plurality of displays.

6. The display robot of claim 5, wherein the plurality of displays is arranged about a circumference of the robot body.

7. The display robot of claim 1, wherein the robot body is comprised of a substantially cylindrical portion and a substantially domed portion, where the substantially domed portion is located above the substantially cylindrical portion.

8. The display robot of claim 1, wherein the power source has an electrical interface for recharging from a docking station.

9. The display robot of claim 8, wherein the docking station comprises a data link for communicating between a data source and the playback device.

10. A display robot, comprising:
a robot body having a display for playing a data signal, the robot body carrying the display;
the robot body having a mobile base that allows the robot body to move along a surface;
the robot body having a power source for driving the robot body along the surface;
an external data system for storing the data signal, the external data system being in communication with a playback device via a data link;
the playback device being operably connected with the display, for playing back the data signal on the display.

11. The display robot of claim 10, wherein the display further comprises a speaker for playback of an audio data signal.

12. The display robot of claim 10, wherein the robot body further comprises a plurality of sensors to detect obstacles.

13. The display robot of claim 10, wherein the robot body has a plurality of displays.

14. The display robot of claim 13, wherein the plurality of displays is arranged about a circumference of the robot body.

15. The display robot of claim 10, wherein the robot body is comprised of a substantially cylindrical portion and a substantially domed portion, where the substantially domed portion is located above the substantially cylindrical portion.

16. The display robot of claim 10, wherein the power source has an electrical interface for recharging from a docking station.

17. The display robot of claim 16, wherein the docking station comprises a data link for communicating between a data source and the playback device.

18. A display robot, comprising:
a robot body having a display for playing a data signal, the robot body carrying the display;
the robot body having a mobile base that allows the robot body to move along a surface;
the robot body having a power source for driving the robot body along the surface;
an external data system for storing the data signal, the external data system being in communication with the playback device through a global computer network;
the playback device being operably connected with the display, for playing back the data signal on the display.

19. The display robot of claim 18, wherein the display further comprises a speaker for playback of an audio data signal.

20. The display robot of claim 18, wherein the robot body further comprises a plurality of sensors to detect obstacles.

21. The display robot of claim 18, wherein the robot body has a plurality of displays.

22. The display robot of claim 21, wherein the plurality of displays is arranged about a circumference of the robot body.

23. The display robot of claim 18, wherein the robot body is comprised of a substantially cylindrical portion and a substantially domed portion, where the substantially domed portion is located above the substantially cylindrical portion.

24. The display robot of claim 18, wherein the power source has an electrical interface for recharging from a docking station.

25. The display robot of claim 24, wherein the docking station comprises a data link for communicating between a data source and the playback device.
